(19) United States
(12) Patent Application Publication
(10) Pub. No.: US 2015/0206131 A1
(43) Pub. Date: Jul. 23, 2015

(54) SYSTEM AND METHOD FOR ADAPTIVE RESPONSE PROTOCOL

(71) Applicant: MASTERCARD INTERNATIONAL INCORPORATED, Purchase, NY (US)

(72) Inventors: Simon Phillips, York (GB); Simon Collins, Guildford (GB)

(73) Assignee: MASTERCARD INTERNATIONAL INCORPORATED, Purchase, NY (US)

(21) Appl. No.: 14/262,185

(22) Filed: Apr. 25, 2014

Related U.S. Application Data
(60) Provisional application No. 61/928,589, filed on Jan. 17, 2014.

(51) Int. Cl. G06Q 20/34; G06Q 20/36; G06Q 20/32; G06Q 20/10

(52) U.S. Cl. CPC G06Q 20/34; G06Q 20/10; G06Q 20/36; G06Q 20/322

(57) ABSTRACT

A method includes receiving a request for a response, where the request has a defined response deadline. The method further includes determining whether optimal response information is available prior to the defined response deadline. Based on a result of such determination, non-optimal information is sent prior to the defined response deadline in response to the request. Thereafter, the optimal response information is sent asynchronously.

### CROSS REFERENCE TO RELATED APPLICATION

This application claims the benefit of U.S. Provisional Patent Application No. 61/928,529 filed on Jan. 17, 2014, the contents of which are hereby incorporated by reference for all purposes.

### BACKGROUND

When a computer system receives and responds to requests, it may in some situations be expected or required to provide its response within a predetermined response time. This may be necessary, for example, to comply with a pre-determined service level standard or to accommodate the time-out period for the requesting device. In the latter case, if the system that receives the request does not respond timely, the requesting device may time out, and thereafter sends another request for the same service. Thus failure to comply with the required response time may lead to increased request traffic or may hamper proper operations in other ways.

One difficulty that may be faced in the system that receives the request is that it in turn may need to request at least some of the needed information from another system, which may not respond in time for the former system to meet its required response time. Thus, it would be desirable to provide a response protocol that supports timely responses to requests, even where the information needed for the responses is not available in time to comply with the required response time.

### BRIEF DESCRIPTION OF THE DRAWINGS

Features and advantages of some embodiments of the present disclosure, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 illustrates a system within which some embodiments may be implemented.

FIG. 2 is a block diagram depicting communication flows that may involve request handling in accordance with aspects of the present disclosure.

FIG. 3 is a block diagram representation of a computer system provided in accordance with some aspects of the present disclosure to implement an issuer proxy service provider block shown in FIG. 2.

FIG. 4 is a flow chart that illustrates a process that may be performed in the computer system of FIG. 3 in accordance with aspects of the present disclosure.

### DETAILED DESCRIPTION

In general, and for the purpose of introducing concepts of embodiments of the present disclosure, a computer system that provides responses to requests may adapt the responses provided based on whether necessary information is available within the time required for the response. If the necessary information is available in time, then the computer system provides a complete, timely response. If the necessary information is not available in time, the computer system provides an adequate, but less than ideal, response to the requesting device within the required response time period. Thereafter, when the information necessary for a complete response becomes available, the computer system asynchronously sends the complete response to the requesting device.

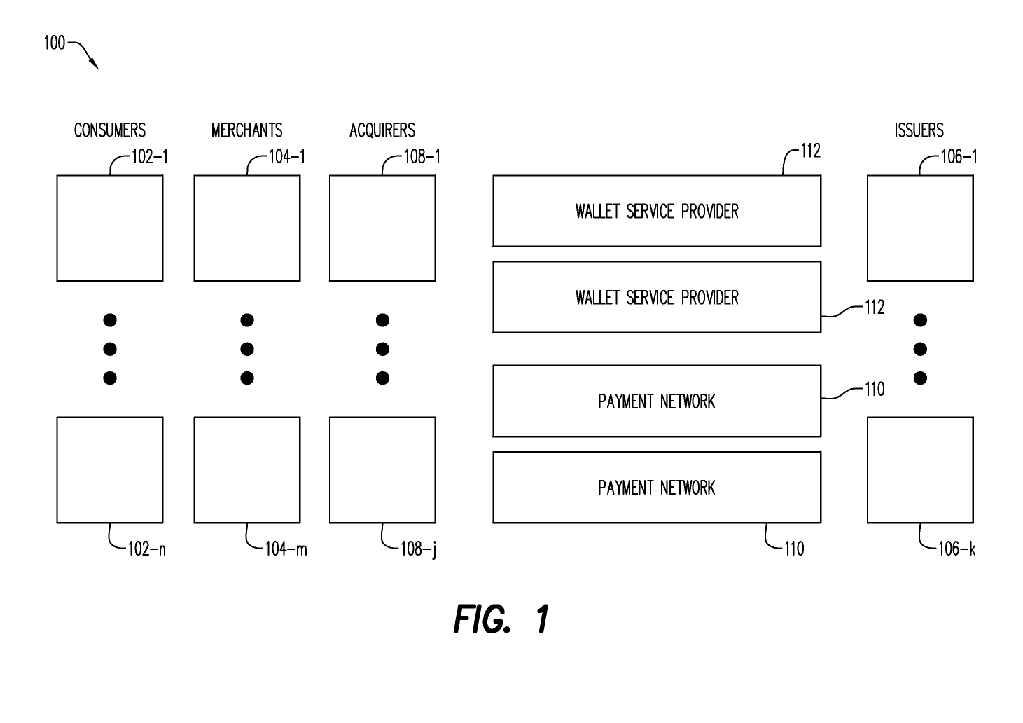

FIG. 1 illustrates a system 100 within which some embodiments may be implemented. In particular, the system 100 provides an environment in which payment transactions may take place. The purpose of the system 100 is to service requests for payment transactions that are initiated by consumers, who are indicated by blocks 102-1 through 102-n (and who hereafter may be referred to collectively as “consumers 102”). As is well known, the consumers 102 may be holders of payment card accounts through which payments may be made for purchase transactions with merchants, the latter being indicated by blocks 104-1 through 104-m (and which hereafter may be referred to collectively as “merchants 104”). The number of consumers 102 served by the system 100 may be many millions. It is not unusual for a particular consumer to hold several payment card accounts; a considerable number of consumers may each have five to ten payment card accounts issued in their name. The number of merchants that accept payment via the consumers' payment card accounts may be many thousands, and even millions if the worldwide nature of payment networks is considered.

As is also well known, the payment card accounts held by the consumers 102 and honored by the merchants 104 are typically issued by financial institutions (often banks, and referred to as “issuers”). The issuers are indicated by blocks 106-1 through 106-k in FIG. 1 and may hereafter collectively be referred to as “issuers 106”. Typical types of payment card accounts issued by the issuers 106 may include credit card accounts and debit card accounts. Some of the larger issuers issue hundreds of thousands or millions of payment card accounts.

In a typical payment transaction, a consumer 102 presents his or her payment card (not separately shown) to a merchant 104. The merchant, via a suitable device such as a point of sale (POS) terminal (not separately shown), reads payment card account number information and other information from the card, and also enters transaction information such as the amount of the transaction. To route the transaction through the payment system, the merchant relies on a bank with which it has an established relationship and maintains typically one or more accounts. Such a bank is typically referred to as an “acquirer”; acquirer banks are indicated by blocks 108-1 through 108-j in FIG. 1 (collectively the acquirers may hereinafter be referred to as “acquirers 108”). A considerable number of banks serve as acquirers for one or more payment networks and some of them may service thousands of merchants, both large and small.

It is also well known to those skilled in the art that the payment card accounts issued by the issuers 106 are typically branded with the name of an operator of a large payment network. One of the best known brands of payment card is “MasterCard®”; this brand is owned by MasterCard International Incorporated, the assignee hereof. In FIG. 1, two payment networks 110 are indicated, of which one may be assumed to be the well-known Banknet system operated by MasterCard International Incorporated. In real world payment environments, more than two payment networks may be in operation.

It was mentioned above that, in a typical payment transaction, the merchant obtains the payment card account number from the consumer's payment card. The merchant includes this information, along with transaction information and other information, in an authorization request that the merchant forwards (perhaps via a payment services provider—not shown) to the merchant's acquirer bank. The acquirer routes the authorization request via the relevant payment network 110 to the issuer 106 of the payment card account in question. If all is in order, the issuer transmits a favorable authorization response, which is routed back through the payment network 110 to the acquirer 108 and then on to the merchant 104. The purchase transaction between the merchant and the customer is completed, and the payment for the transaction may thereafter be consummated in due course via a charge to the consumer's account and subsequent settlement processes involving the issuer and the acquirer and the acquirer and the merchant.

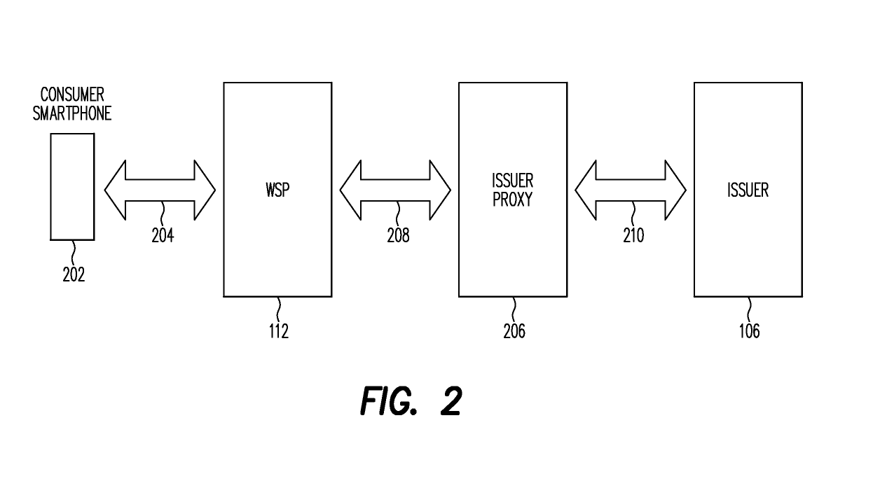

In the above description of a typical payment transaction, it was assumed that the consumer presented a card to be read by the merchant/POS device. However, it is increasingly the case that consumers may use their smartphones to initiate payment transactions. While in some approaches, the payment card account number and related information may be stored in the smartphone and read via local communication at the point of sale, other approaches have also been proposed. For example, systems have been proposed in which the consumer is able to establish a “digital wallet” stored in a central computer maintained by a “wallet service provider” and accessible by communications initiated by the consumer's smartphone. By analogy with a conventional physical wallet, the consumer's digital wallet may contain information that represents various accounts held by the consumer, including for example payment card accounts. Two wallet service providers 112 are shown in FIG. 1, although there may be a greater or smaller number than two in a given payment environment. With establishment of a digital wallet, the transaction information flow of cardholder/consumer merchant acquirer payment network issuer and then back may be altered to include accessing payment card account information stored in the consumer's digital wallet maintained by a wallet service provider 112. It is anticipated that consumers may find it convenient or advantageous to access their digital wallets for payment purposes by using their smartphones. Of course, to enable payment transactions by use of a digital wallet, it may be necessary that various set-up processes for the digital wallet occur first. Examples of such set-up processes will be described below, including the following discussion of FIG. 2.

FIG. 2 is a block diagram depicting communication flows that may involve request handling in accordance with aspects of the present disclosure. In particular, the communication flows shown in FIG. 2 may be such as could be undertaken (a) in response to a consumer's efforts to add one or more payment card accounts to his/her digital wallet and/or (b) in connection with other set-up processes for the consumer's digital wallet. Indicated at 202 is a smartphone belonging to a consumer. The consumer may use his/her smartphone to engage in communications (as indicated at 204) with his/her wallet service provider 112. For example, such communications may include the consumer requesting enrollment in the wallet service provider's service offerings and/or may include the consumer requesting that one or more of the consumer's payment card accounts be added to the consumer's digital wallet maintained for the consumer by the wallet service provider 112. In some embodiments, the consumer may use a mobile browser running on the smartphone 202 to transmit requests to the wallet service provider 112.

To service at least some of the consumer's requests, the wallet service provider 112 may need to receive data that is in the possession of the issuer 106 (FIG. 2) of one or more of the consumer's payment card accounts. For convenience and efficiency in handling requests from the wallet service provider 112, an issuer proxy service computer 206 (also shown in FIG. 2) may be established to aid in routing and resolving requests from the wallet service provider 112. Thus there may be one or more communication paths 208 between the wallet service provider 112 and the issuer proxy service computer 206 and one or more communication paths 210 between the issuer proxy service computer 206 and the issuer 106. In some embodiments, the issuer proxy service computer 206 may be operated by the operator of one of the payment networks 110 referred to above in connection with FIG. 1. In practice, the issuer proxy service computer 206 may handle requests from more than one wallet service provider, and may route the requests to a considerable number of issuers. It will also be understood that requests from many consumers may be serviced by an arrangement such as that shown in FIG. 2.

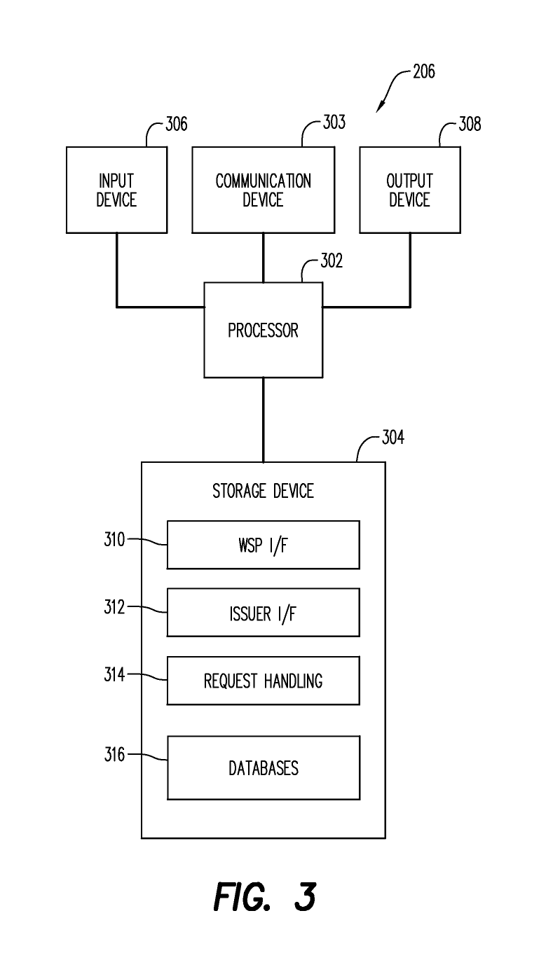

FIG. 3 is a block diagram representation of an embodiment of the issuer proxy service computer 206 as provided in accordance with some aspects of the present disclosure. The issuer proxy service computer 206 may be conventional in its hardware aspects, but may be controlled by software to cause it to function as described herein. The issuer proxy service computer 206 may include a computer processor 302 operatively coupled to a communication device 303, a storage device 304, an input device 306 and an output device 308.

The computer processor 302 may be constituted by one or more conventional processors. Processor 302 operates to execute processor-executable steps, contained in program instructions described below, so as to control the issuer proxy service computer 206 to provide desired functionality.

Communication device 303 may be used to facilitate communication with, for example, other devices (such as computers operated by one or more wallet service providers and a considerable number of computers operated by issuers). For example (and continuing to refer to FIG. 3), communication device 303 may comprise numerous communication ports (not separately shown), to allow the issuer proxy service computer 206 to communicate simultaneously with a number of other computers and other devices.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 302. The programs comprise program instructions (which may be referred to as computer readable program code means) that contain processor-executable process steps of the issuer proxy service computer 206, executed by the processor 302 to cause the issuer proxy service computer 206 to function as described herein.

The programs may include one or more conventional operating systems (not shown) that control the processor 302 so as to manage and coordinate activities and sharing of resources in the issuer proxy service computer 206, and to serve as a host for application programs (described below) that run on the issuer proxy service computer 206.

The programs stored in the storage device 304 may also include software (indicated by block 310) that controls the processor 302 to provide a communications interface with the wallet service provider 112. In addition, the storage device 304 may store software (indicated by block 312) to control the processor 302 to provide a communications interface with the issuer 106 (or with a number of issuers). In some embodiments, the same communications software may provide interfaces with both the wallet service provider 112 and with the issuer(s) 106.

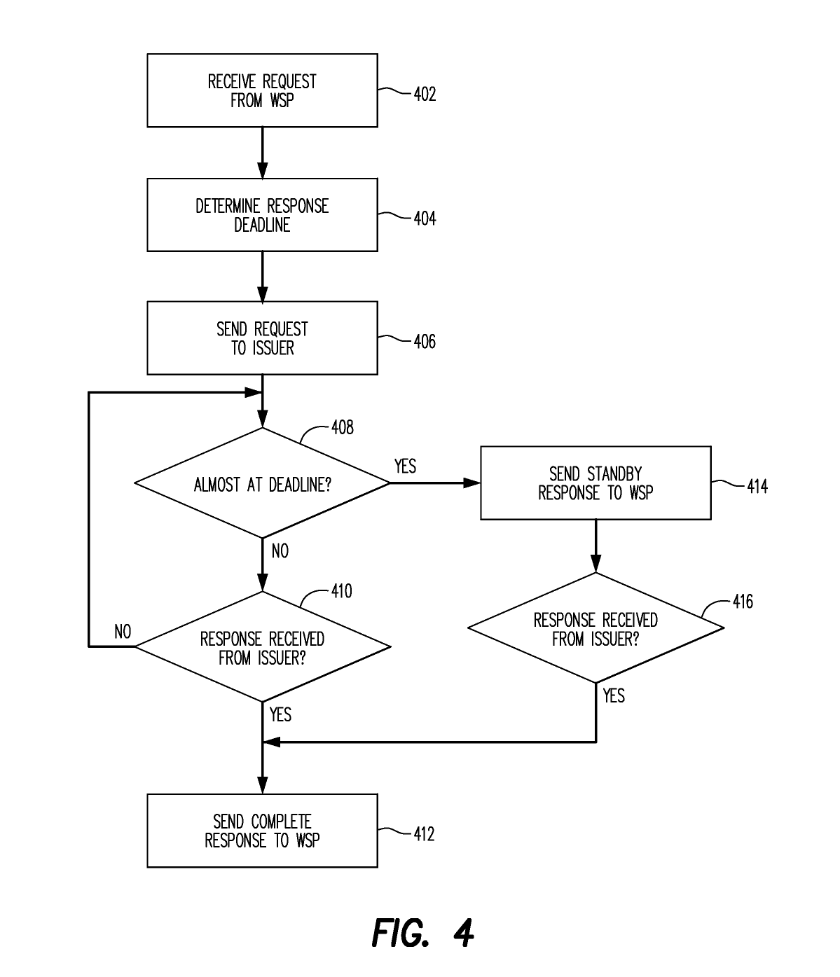

The storage device 304 may also store a request handling application program 314. The request handling application program 314 may receive and service requests from the wallet service provider 112, as briefly referred to above in connection with FIG. 2 and as described in more detail below in connection with FIG. 4.

Continuing to refer to FIG. 3, the storage device 304 may also store, and the issuer proxy service computer 206 may also execute, other programs, which are not shown. For example, such programs may include a reporting application, which may respond to requests from system administrators for reports on the activities performed by the issuer proxy service computer 206. The other programs may also include, e.g., database management software, device drivers, etc.

The storage device 304 may also store one or more databases 316 required for operation of the transaction analysis computer 900.

FIG. 4 is a flow chart that illustrates a process that may be performed in the issuer proxy service computer 206 of FIG. 3 in accordance with aspects of the present disclosure.

At 402 in FIG. 4, the issuer proxy service computer 206 receives from the wallet service provider 112 a request that will allow the wallet service provider 112, in turn, to respond to a request from a consumer. In some embodiments, the request may be any one of a variety of different types of request. For example, the request may be sent by the wallet service provider 112 to determine whether a particular payment card account (belonging to a particular consumer) is available to be “digitized” (i.e., to determine whether the issuer has designated the particular payment card account as one for which relevant data may be downloaded to the account holder's digital wallet). In another possible type of request, the wallet service provider 112 may be seeking to verify that the consumer requesting digitization of the payment card account is actually the account holder or an authorized user of the account. In still another type of request, the wallet service provider 112 may be asking for a software/data image of the issuer's service for loading into the consumer's smartphone 202.

Other types of requests from the wallet service provider 112 may relate to specific transactions, rather than configuration of a consumer's digital wallet. For example, the wallet service provider 112 may request transaction details and authentication credentials, such as for example, “crypto-validation” when the consumer's smartphone is used for a payment transaction.

In at least some of these cases, it may be necessary for the issuer proxy service computer 206 to obtain from the relevant issuer at least some of the information requested by the wallet service provider 112. It will often also be the case that the wallet service provider 112 expects to receive a response from the issuer proxy service computer 206 within a predetermined response time period. (The endpoint of that response time period may be referred to as the “response deadline.”) If the wallet service provider 112 does not receive the response from the issuer proxy service computer 206 by the response deadline, the wallet service provider 112 may time out the request, resubmit the request, etc. In some embodiments, the request itself may contain an indication of when the response deadline is (i.e., how long the issuer proxy service computer 206 has to respond to the request).

In some embodiments, the wallet service provider 112 may have adopted a protocol such that it makes modest adjustments to the length of requested response time periods to improve or optimize operations. For example, the wallet service provider 112 may track the timing at which it is receiving responses for various requests and may increase the requested response time period by a modest amount if it appears likely that such an increase would significantly reduce the number of untimely responses, time-outs, resubmits, etc. Thus the requested response time period may vary from request to request received by the issuer proxy service computer 206 from the wallet service provider 112. The variation in the requested response time periods may, for example, be applied so as to provide the wallet service provider 112 with a certain level of service.

In other embodiments, the issuer proxy service computer 206 may have stored data that indicates the response deadline for the request as a service level standard, and this may have occurred during a set-up or configuration process prior to the issuer proxy service computer 206 receiving the request referred to in connection with block 402. Depending on what configuration/arrangement has been made, the issuer proxy service computer 206 may determine the response deadline for the current request by referring to such previously stored data or by reading the relevant information from the current request. In other embodiments, the issuer proxy service computer 206 may determine the response deadline for the request in another manner.

The determination by the issuer proxy service computer 206 of the response deadline is represented at 404 in FIG. 4.

At 406 in FIG. 4, the issuer proxy service computer 206 sends a request to the issuer 106 for such information as the issuer proxy service computer 206 may need to respond to the request it received at 402 from the wallet service provider 112. In some embodiments, the indicated order of blocks 404 and 406 may be reversed and/or the two steps may be performed simultaneously or virtually simultaneously.

As indicated in FIG. 4, a decision block 408 may follow blocks 402-406. At decision block 408, the issuer proxy service computer 206 may determine whether the current time is close to the response deadline that is defined for the request received at 402. In other words, the issuer proxy service computer 206 may await the response it requested from the issuer 106 until a predetermined time shortly prior to the response deadline. Thus, if at decision block 408 it is determined that the current time is not close to the response deadline, the issuer proxy service computer 206 may next determine, at decision block 410, whether it has received the response it requested from the issuer 106. (The term “close to the response deadline” may refer to a point in time that may be determined according to the context of the request/response process. It may, for example, be the point in time that is 90% of the way from the beginning of the response period to the end of the response period. Alternatively, it may be a point in time that is one second or a few seconds prior to the end of the response period.) If the issuer proxy server computer 206 makes a positive determination at decision block 410, then (as indicated at block 412) the issuer proxy service computer 206 dispatches to the wallet service provider 112 a complete response to the request received at 402, including information that reflects the response received from the issuer. Since, by receiving the response from the issuer 106 in time before the response deadline, the issuer proxy service computer 206 has all it needs for a complete response for the wallet service provider 112, it may be said that in this case the wallet service provider 112 has available “optimal” data for its response to the request from the wallet service provider 112.

Referring again to decision block 410, if it is determined at that block that the issuer proxy service computer 206 has not received the requested response from the issuer 106, then the process of FIG. 4 loops back to decision block 408, as the issuer proxy service computer 206 continues to wait for the response from the issuer 106. However, if at decision block 408 the issuer proxy service computer 206 determines that the current time is close to the response deadline, then the process branches from decision block 408 to block 414. At block 414, the issuer proxy service computer 206 may formulate and send to the wallet service provider 112 a back-up or stand-by response to the request received at 402. For example, the issuer proxy service computer 206 may generate the stand-by response referred to in block 414 based on one or more rules that may have been configured in the issuer proxy service computer 206; such rules may possibly be based on pre-existing instructions from the issuer 106 for the particular payment card account in question and/or for any payment card account having certain characteristics and/or for any payment card account issued by the issuer 106. In addition, or alternatively, the rule(s) that determine the nature of the stand-by response may at least in part take into account the nature of the request that was received at 402 by the issuer proxy service computer 206 from the wallet service provider 112.

The response provided at 414 may be such as to aid the wallet service provider 112 in handling the request from the consumer, but perhaps not as completely and/or satisfactorily as the type of response that would have been provided by the issuer proxy service computer 206 if the process of FIG. 4 had reached block 412 from decision block 410 (i.e., based on the requested information from the issuer). In addition or alternatively, the stand-by response may be simply a sort of “hold on for further information” type of response that would prompt the wallet service provider 112 not to time out or retry, or to move on to another portion of its interaction with the consumer, with the current particular aspect of the interaction to be revisited at a later time during the interaction; alternatively or in addition, the response from the issuer proxy service computer 206 at 414 to the wallet service provider 112 may indicate that the wallet service provider 112 may proceed with the interaction with the consumer, but with the possibility (not necessarily disclosed to the wallet service provider 112) that a more definitive response may come later from the issuer proxy service computer 206 to, e.g., abort or terminate the interaction with the consumer by, e.g., denying the consumer's request. This could occur, for example, if a response were ultimately received by the issuer proxy service computer 206 from the issuer to indicate, e.g., that the payment card account in question is not eligible for inclusion in the consumer's digital wallet or that for some other reason the request (whatever it may be) from the consumer is not permitted to go forward.

Following block 414 in FIG. 4 is a decision block 416. At 416, the issuer proxy service computer 206, or a processing thread thereof, may idle until the issuer proxy service computer 206 receives a response from the issuer 106 to the request that the issuer proxy service computer 206 sent at block 406. If the issuer proxy service computer 206 makes a positive determination at decision block 416 (i.e., if the issuer proxy service computer 206 determines that it has received the response from the issuer), then the process of FIG. 4 may advance from decision block 416 to block 412. In this case the execution of block 412 involves the issuer proxy service computer 206 sending asynchronously to the wallet service provider 112 a more complete and/or more satisfactory or definitive response (as compared to the response provided at 414), based on the information provided by the issuer.

To at least partially summarize the above, the response provided at 412, following decision block 416 contains “optimal” response information in the sense that such information in some way more completely, definitively or satisfactorily advances the purposes of the wallet service provider 112 and/or the system as a whole, than the response information provided at 414. The latter information may be considered to be “non-optimal” in the sense that it is at least in some way less complete, definitive or satisfactory than the information that could or would be provided at step 412. It will also be understood that, in the example process described above, the issuer proxy service computer 206 proceeded to block 414 based on its determination that the optimal response information was not available prior to the defined response deadline for the request received at 402. It is not intended to imply herein that response information is “optimal” only if it is perfectly complete, definitive or satisfactory.

According to one example of the process of FIG. 4, it may be intended at block 406 to request (for subsequent forwarding to the wallet service provider 112) a considerable number of data items (say 100, as might be the case in a request for past transaction data). It may be the case under some circumstances that as the deadline approaches, the number of data items received by the issuer proxy service computer 206 from the issuer 106 consists of N<100 of the data items. In such a case the non-optimal response made by the issuer proxy service computer 206 may be to send the available N data items immediately to the wallet service provider 112, with the balance of the requested data items (lines of transactions) to be sent asynchronously thereafter.

As another example, the information requested by the issuer proxy service computer 206 may include an additional identity check from a third party information supplier. If the requested additional information is not available as the deadline approaches, the non-optimal response from the issuer proxy service computer 206 may be to approve the transaction, subject to a later asynchronous possible rejection of the transaction or the request from the wallet service provider 112 if, after the non-optimal response, the additional identity check information is received and indicates a problem.

In the embodiments referred to above, whether optimal response information was available depends on the timing at which the issuer responds to the request from the issuer proxy service computer 206. However, the availability of the optimal response information may in other embodiments be dependent on one or more other factors, including for example processing conditions internal to the issuer proxy service computer 206.

In some embodiments, the issuer proxy service computer 206 may not have any of the information it needs for an optimal response until it receives the response from the issuer, and thus may receive all of the optimal response information from the issuer after the issuer proxy service computer 206 sends the non-optimal response information to the wallet service provider (in cases where the issuer does not respond prior to the response deadline). In other embodiments, the issuer proxy service computer 206 may have some, but not all information needed for an optimal response prior to receiving the response from the issuer.

In the embodiments referred to above, the provision of non-optimal response information followed by optimal response information being provided subsequently and asynchronously was described within the context of an issuer proxy service computer that services requests from one or more wallet service providers and that requests information from one or more payment card account issuers. Nevertheless, the teachings of the present information are not limited to such a context. For example, the computer that receives the initial request and responds with non-optimal information depending on availability (or non-availability) of optimal information need not be an issuer proxy service computer and/or need not be responding to a wallet service provider.

Within the context of the issuer proxy service computer as described above, that computer and/or one or more other computers operated by the operator of the issuer proxy service computer may provide one or more additional types of services to facilitate digital wallet services in addition to those services of the issuer proxy service computer that were described above. These additional types of services can include, but are not limited to: (a) a service to aid issuers in loading and configuring payment card accounts; (b) a service to aid one or more wallet service providers in loading and configuring consumers' smartphones or other devices; (c) a service to aid issuers to generate a digital image of a payment card account for loading into consumers' smartphones and other devices; (d) a transaction validation service used by issuers to check that a current transaction was originated by the genuine digital card; (e) a transaction mapping and conversion service that converts transactions received from the digital card into a format expected by one or more issuers and that includes an “FPAN” (funding primary account number) and a “DPAN” (digital primary account number; i.e., a PAN that's stored in a consumer smartphone and is used to route a transaction to a mobile network operator); and (f) one or more customer interfaces for use by wallet service providers and/or issuers in managing service usage and/or settings.

The above teachings concerning providing a response with non-optimal response information when optimal response information is unavailable are at least potentially relevant to any or all of these types of service, and also as noted above may be applied in entirely different contexts from those described above. In the example process described above in connection with FIG. 4, it will be understood that a computer operated by a wallet service provider performs the role of a requesting device; the issuer proxy service computer performs the role of a request processing device; and a computer operated by an issuer performs the role of an information source device. One or more, or all, of these roles may be performed by different devices and/or different types of devices in other embodiments.

With the sending of a non-optimal response, to be followed asynchronously with an optimal response, a service-providing computer may provide improved service to requesting devices. This improvement may be particularly effective in cases where the availability of optimal information may be unpredictable, such as when the service-providing computer is dependent on receiving responses from onward devices (e.g., payment card issuers' computers in the context described above) that may not provide a predictable degree of timeliness in their responses. Moreover, with the teachings as described above, the number of time-outs and/or resubmissions of requests from service-requesting devices may be reduced.

As used herein and in the appended claims, “asynchronously” refers to dispatching of information without a particular relationship in time to a particular request, and/or outside of a defined period of response for a particular request.

A request should be understood to have a defined response deadline if a deadline has been defined for responding to the request and regardless of whether data indicative of the deadline is contained in the request itself.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

The term “payment card network” or “payment network” is used to refer to a payment network or payment system such as the systems operated by MasterCard International Incorporated (which is the assignee hereof), or other networks which process payment transactions on behalf of a number of merchants, issuers and cardholders.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, a debit card, prepaid card, or other type of payment instrument whether an actual physical card or virtual.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving in a request processing device, from a requesting device, a request for a response, the request having a defined response deadline;
determining whether optimal response information is available prior to the defined response deadline;
based on a result of the determining step, sending non-optimal response information from the request processing device to the requesting device prior to the defined response deadline in response to the received request; and
following the sending step, asynchronously sending the optimal response information from the request processing device to the requesting device.

2. The method of claim 1, wherein the defined response deadline is indicated in the request.

3. The method of claim 1, wherein an indication of the defined response deadline is stored in the request processing device as a service level standard prior to the receiving step.

4. The method of claim 1, further comprising:
following the sending of the non-optimal response information, receiving, in the request processing device from an information source device, at least a portion of the optimal response information.

5. The method of claim 4, wherein the information source device is a computer operated by an issuer of payment card accounts.

6. The method of claim 5, wherein the requesting device is a computer operated by a wallet service provider.

7. The method of claim 4, wherein the request processing device receives all of the optimal response information from the information source device following the sending of the non-optimal response information.

8. The method of claim 1, wherein the determining step is performed by the request processing device.

9. An apparatus comprising:
a processor; and
a memory in communication with the processor, the memory storing program instructions, the program instructions controlling the processor to perform operations as follows:
receiving, from a requesting device, a request for a response, the request having a defined response deadline;
determining whether optimal response information is available prior to the defined response deadline;
based on a result of the determining step, sending non-optimal response information to the requesting device prior to the defined response deadline in response to the received request; and
following the sending step, asynchronously sending the optimal response information to the requesting device.

10. The apparatus of claim 9, wherein the defined response deadline is indicated in the request.

11. The apparatus of claim 9, wherein an indication of the defined response deadline is stored in the apparatus as a service level standard prior to the receiving step.

12. The apparatus of claim 9, wherein the processor is further operative to receive from an information source device, following the sending of the non-optimal response information, at least a portion of the optimal response information.

13. The apparatus of claim 12, wherein the information source device is a computer operated by an issuer of payment card accounts.

14. The apparatus of claim 12, wherein all of the optimal response information is received by the apparatus from the information source device following the sending of the non-optimal response information.

15. A medium having program instructions stored thereon, the medium comprising:
instructions to receive, from a requesting device, a request for a response, the request having a defined response deadline;
instructions to determine whether optimal response information is available prior to the defined response deadline;
instructions to send, based on a result of the determining step, non-optimal response information to the requesting device prior to the defined response deadline in response to the received request; and
instructions to asynchronously send the optimal response information to the requesting device following the sending of the non-optimal response information.

16. The medium of claim 15, wherein the defined response deadline is indicated in the request.

17. The medium of claim 15, wherein an indication of the defined response deadline is stored as a service level standard in association with the medium prior to the receiving step.

18. The medium of claim 15, wherein the medium further comprises instructions to receive from an information source device, following the sending of the non-optimal response information, at least a portion of the optimal response information.

19. The medium of claim 18, wherein the information source device is a computer operated by an issuer of payment card accounts.

20. The medium of claim 19, wherein the requesting device is a computer operated by a wallet service provider.
